(19) United States
(12) Patent Application Publication
(10) Pub. No.: US 2005/0014643 A1
(43) Pub. Date: Jan. 20, 2005

(54) Electrochemical double-layer energy storage cells with high energy density and high power density

(76) Inventors: Hedi Lini, Lescar (FR); Chantal Lini, Lescar (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/432,590

(22) PCT Filed: Nov. 26, 2001
(86) PCT No.: PCT/FR01/03724

(30) Foreign Application Priority Data
Nov. 27, 2000 (FR) 00/15283

(51) Int. Cl. C01B 31/10

(52) U.S. Cl. 502/432

(57) ABSTRACT

The invention concerns a method for preparing activated carbons based on wood, preferably softwood and in particular pine wood, for making electrodes for energy storage cells, particularly for super-capacitors. Said activated carbons have a volume of mesopores less than 75% of the total pore volume and a volume of micropores less than 57% of the total pore volume. The invention also concerns a method for making an electrode for energy storage cell, comprising the application of such an activated carbon on a support, preferably by coating derived from a slurry. The energy storage cells using said activated carbons advantageously provide a better compromise between energy density and power density.

The present invention relates to a process for the preparation of activated carbons based on wood, preferably on softwood, in particular on pine wood, having a specific pore structure for the manufacture of electrodes for electrochemical double-layer energy storage cells.

The invention also relates to the electrodes thus obtained and to the electrochemical double-layer energy storage cells comprising such electrodes and to a process for the manufacture of these electrodes.

The electrochemical storage of energy can be carried out via three different devices each having their own characteristics.

In a conventional electrochemical storage battery, the two nonpolarizable electrodes are separated by an ionic conductor. Charge transfers take place via slow oxidation/reduction reactions. The maximum power available is therefore low (<400 W/kg). On the other hand, the energy stored is high (>30 Wh/kg).

In a conventional capacitor, the two polarizable electrodes are separated by a thin insulator. In this type of system, the operating principle is based on the formation of an electrical double layer by accumulation of charges within the electrodes on either side of the insulator. This phenomenon is very fast and allows charge-discharge periods of the order of a millisecond. The pulse power provided by such systems is therefore extremely high (>10⁴ W/kg). On the other hand, the amount of energy stored is low (<10⁻² Wh/kg).

In a supercapacitor, the two polarizable electrodes of high specific surface are separated by an ionic conductor. As the amount of charge stored is proportional to the specific surface of these electrodes, there is great advantage in such a device in comparison with a conventional capacitor. Thus, in terms of energy stored and of power available, the supercapacitor exists as a device intermediate between the storage battery and the capacitor.

The use of supercapacitors is well established in various applications. Such capacitors can be described in terms of energy density (kilowatt-hour/kg) and power density (watt/kg) characteristics. Capacitors with a high energy density store a relatively high capacitance, which is slowly discharged over a period of a few minutes. On the other hand, capacitors with a high power density can deliver their energy rapidly (in a few milliseconds). Various practical applications have different requirements in terms of energy and power. For example, memory backup devices require a reasonably high energy density but do not require that the energy be delivered rapidly (low power, long discharge time). Furthermore, an application such as starting an automobile engine requires a very high power and most of the energy has to be delivered in a few milliseconds. Other applications require combinations of the energy and power densities which are intermediate between these two extremes.

Electrical devices for energy storage comprising electrodes based on activated carbons resulting from lignocellulose materials are known. These devices, which are generally known as electrochemical carbon double-layer capacitor or CDLCs, are usually composed of a pair of electrodes (at least one which is a carbon paste electrode), a separator and a collector, impermeable to ions, which conducts current.

The activated carbons are characterized by a high total specific surface (generally in the range 500-2 500 m²/g). They are differentiated by their origin or precursor (coal, wood, fruit shells, and the like) and by the type of activation, physical or chemical, which they have been subjected to.

The pores in the activated carbon are classified according to their size into micropores (diameter <2 nm), mesopores (diameter 2-50 nm) or macropores (diameter >50 nm).

High specific surfaces and a relatively low cost render activated carbons useful in many applications, including that of electrical energy storage devices.

It is known that some types of activated carbons have an influence on the energy and power densities of the CDLC. This is because capacitors have been able to be improved either with regard to their power density or with regard to their energy density.

Carbons obtained by heat treatment of precursor which is activated in an alkaline bath at a high temperature are known, for example from U.S. Pat. No. 5,430,606. The energy storage cells manufactured with these carbons exhibit a good energy density but prove to have a poor performance with regard to the power density. Thus, their use is not made possible in applications requiring rapid delivery of the energy. In addition, the preparation process is expensive.

CDLCs with a high energy density obtained from activated carbons having a specific pore structure composed essentially of micropores are also known from U.S. Pat. No. 5,905,629. Furthermore, CDLCs with a high power density from activated carbons with an equivalent content of mesopores are also known from U.S. Pat. No. 5,926,361. These carbons are obtained by an activation process followed by a heat treatment of the activated carbon precursor.

However, these CDLCs are not suitable for intermediate applications requiring both a high energy density and rapid delivery of the energy. In addition, the process for manufacturing the carbons is expensive.

In addition, carbons having a pore volume of 0.3 to 2.0 cm³/g, including 10 to 60% of micropores, 20 to 70% of mesopores and not more than 20% of macropores, and exhibiting a specific surface of 1 000 to 2 500 m²/g are known from EP 1 049 116. The carbons disclosed are obtained exclusively from polymers.

It is therefore an object of the present invention to provide a process for the manufacture of activated wood carbon exhibiting a porosity profile suitable for the electrodes of electrochemical double-layer energy storage cells.

An object of the invention is thus to provide a process for the manufacture of a porous carbonaceous material. Another object of the invention is to provide an electrode based on such materials and energy storage cells exhibiting a better compromise between the power density and the energy density in comparison with the preexisting cells of this type. Another subject matter of the invention is a process for the manufacture of such improved energy storage cells.

In the context of this account, the term “energy storage cells” is understood to mean any device for the storage of electrochemical energy, supercapacitors and in particular CDLCs.

The cells according to the invention are obtained by virtue of activated carbons based on wood, preferably on softwood, in particular on pine wood, which exhibit a specific pore distribution and in particular have contents of mesopores and micropores of less than 75% of the total pore volume.

This specific pore distribution is partly due to the quality of the starting material, wood, preferably softwood, and in particular pine wood. The carbons obtained from pine wood, which are particularly preferred, are characterized in addition by high purity.

The activated carbons exhibit a content of mesopores of less than 75%, preferably of between 40 and 60%, with respect to the total pore volume. The volume of mesopores of the activated carbon used is preferably between 0.4 and 0.8 cm³/g. Preferably, these carbons exhibit a pore volume of greater than 0.8 cm³/g, preferably of greater than 1 cm³/g, a median pore width of 15 to 50 nm and a specific surface of greater than 800 m²/g.

These activated carbons also preferably exhibit (as a function of the total pore volume) a content of macropores of less than 0.3 cm³/g. The relative content of macropores is preferably less than the content of micropores and mesopores. Thus, the activated carbon advantageously comprises less than 25%, preferably less than 10% and even more preferably less than 1% of macropores with respect to the total pore volume.

These carbons are subjected to an activation process so as to increase the surface area of the natural carbonaceous material. Such an activation of the raw material is carried out either by a chemical process or by thermal process. Activation process examples are indicated, for example, in patents U.S. Pat. Nos. 4,107,084, 4,155,878, 5,212,144 and 5,270,017.

An effective porosity of the activated carbons produced by thermal activation is the result of gasification of the carbon at high temperature (after an initial carbonization of the raw material), whereas the porosity of the products activated by chemical dehydration/condensation reaction are produced at low temperature.

The activated carbon precursor used according to the invention is wood, preferably softwood, and in particular pine wood. The wood used can, for example, be in the form of wood chips, wood flour, wood dust, wood sawdust and combinations of these.

The activated carbon can be obtained by chemical activation or, preferably, by thermal or physical activation.

The chemical activation is generally carried out industrially in a simple furnace. The precursor of the raw material is impregnated with a chemical activating agent and the mixture is heated at a temperature of 450° C.-700° C. The chemical activating agents reduce the formation of tars and of other derived products and thus increase the yield. The appropriate chemical activating agents include hydroxides of alkali metal, carbonates, sulfides and sulfates; carbonates of alkaline earth metals, chlorides and phosphates; phosphoric acid; polyphosphoric acid; zinc chloride; sulfuric acid; fuming sulfuric acid; and combinations of these. Phosphoric acid and zinc chloride are preferred among these agents. The preferred among all is phosphoric acid. The precursor is impregnated with activating agent and is then activated at approximately 550° C. As indicated above, the activated carbon is preferably obtained by thermal activation.

In this case, the precursor material is subjected to a carbonization heat treatment at a temperature of between 500 and 800° C. in order to obtain wood carbon, which is subsequently activated at a temperature of greater than 700° C., preferably of between 800 and 1 100° C., and more preferably still at a temperature of between 950 and 1 050° C.

The thermal activation of the wood carbon takes place in a thin layer. The term “thin” is understood to mean a layer with a thickness of approximately 2 to 5 cm. The activation is preferably carried out in a furnace in which the precursor material moves by gravity from the top downward. The activation is advantageously carried out in the presence of steam and/or of carbon dioxide.

The activated carbons capable of being obtained according to the process described above are particularly preferred in the manufacture of electrodes of electrochemical double-layer energy storage cells.

The process for the manufacture of these wood carbons is additionally advantageous in that it is economical.

A typical CDLC is composed of: (1) a pair of electrodes, at least one (preferably both) of which is a carbon paste electrode, (2) a porous separator which conducts ions and (3) a collector which is impermeable to ions, to provide electrical contact between the electrodes and an electrolyte.

The cell preferably exhibits an energy density of greater than 3 Wh/kg, in particular of greater than 4 Wh/kg, and an energy power of greater than 4 kW/kg, in particular of greater than 5 kW/kg.

The novel energy storage cells having a better power density/energy density compromise are derived from activated carbons based on wood. These activated carbons are characterized in that they have a level of micropores with respect to the total pore volume of less than 75%, preferably of between 20 and 40%, with respect to the total pore volume. Preferably, the volume of micropores of the activated carbon used is between 0.2 and 0.6 cm³/g.

The process for the manufacture of electrodes for CDLCs with a high power density and energy density comprises the application to a support of an activated carbon derived from wood having a volume of mesopores and of micropores as defined above.

For the manufacture of electrodes (1), the activated carbon is preferably ground to a size, expressed in d₅₀, of approximately 30 micrometers and preferably to a d₅₀ of approximately 10 micrometers.

Preferably, the application is carried out by preparing beforehand a slip comprising a powdered activated carbon, a binder and a solvent. The slip is applied to the support and the solvent is subsequently evaporated to form a film.

According to the process of the invention, the activated carbons are mixed with a binder, such as a polymer binder, in an aqueous or organic solvent. Thermoplastic or elastomeric polymers or their mixtures which are soluble in said solvent, for example, can be used as polymer binder. Mention may in particular be made, among these polymers, of polyethers, such as polyoxyethylene (POE) or polyoxypropylene (POP), and/or of polyalcohols, such as polyvinyl alcohol (PVA), or of ethylene-vinyl acetate (EVA) copolymers. The solvent can be any aqueous or organic solvent appropriate for dissolving the binder used. Such a solvent is, for example, acetonitrile for polymer binders based on POE, POP, PVA and/or EVA.

The activated carbon is preferably mixed with the polymer in a ratio by weight of 10/90 to 60/40, preferably of 30/70 to 50/50.

The paste obtained is subsequently applied to a support by coating.

It is advantageous for the coating to be carried out on a peelable support, for example using a template, generally flat in shape.

The solvent is subsequently evaporated, for example under a hood. A film is obtained, the thickness of which depends in particular on the concentration of the carbon paste and on the deposition parameters but which is generally between a few micrometers and a millimeter. The thickness is preferably between 100 and 500 micrometers and it is more preferably between 150 and 250 micrometers.

The appropriate electrolytes to be used to produce CDLCs with a high energy density and a high power density comprising at least one electrode based on activated carbon having the capacity to deliver improved energy densities and improved power densities consist of any medium highly conductive of ions, such as an aqueous solution of an acid, of a salt or of a base. If desired, nonaqueous electrolytes (in which water is not used as solvent) can also be used, such as tetraethylammonium tetrafluoroborate (Et₄NBF₄) in acetonitrile or γ-butyrolactone or propylene carbonate.

In the structure of the cell, the electrolyte can have three general functions: as promoter of the conductivity of ions, as source of ions and, if appropriate, as binder for the carbon particles. Sufficient electrolyte should be used to satisfy these functions (although a separate binder can be used to provide the binding function).

Preferably, the carbon paste comprises activated carbon, a binder and a solvent.

One of the electrodes can be composed of another material known in the art.

The current collector (3) which is impermeable to ions can be any electrically-conductive material which is nonconductive to ions. Satisfactory materials to be used to produce these collectors comprise: carbon, copper, lead, aluminum, gold, silver, iron, nickel, tantalum, conductive polymers, nonconductive polymers filled with conductive material so as to render the polymer electrically conductive, and similar materials. The collector (3) must be connected electrically to an electrode (1).

A separator (2), generally made of a highly porous material, is positioned between the electrodes, the functions of which separator are to provide electronic insulation between the electrodes (1) while allowing the ions of the electrolyte to pass. The pores of the separator (2) have to be sufficiently small to prevent electrode-electrode contact between the opposite electrodes (contact would result in a short circuit and a rapid loss in the charges accumulated in the electrode). Generally, any conventional battery separator can be used in a CDLC with a high power density and a high energy density. The separator (2) can be a membrane which is permeable to ions which allows ions to pass through but which prevents electrons from passing.

The manufacturing process and the energy storage cell according to the invention are described in more detail in the following examples. These examples are given by way of illustration and not by way of limitation of the invention.

### EXAMPLES

The activated carbons of the following examples 2S to 5S, sold by the Applicant Company, are obtained industrially according to the process of claim 1 by adjustment of the steam partial pressure and the increase in the residence time in the furnace, making it possible to change from grade 2S to 3S to 4S and to 5S by increasingly expanding the porosity.

### Example 1

Thermally activated carbons derived from pine wood of 2S grade, available from Ceca, are used to produce carbon paste electrodes as described below. This activated carbon is obtained by activation in a thin layer at a temperature of 1 000° C. in the presence of steam.

40 g of 2S activated carbon are first mixed with 60 g of polyoxyethylene (POE) 300 000 (available from Aldrich) in 500 ml of acetonitrile until a homogeneous slip is obtained.

This slip is subsequently applied by coating using a doctor blade in a PTFE template.

The solvent is allowed to evaporate under a hood at ambient temperature for approximately 12 hours. A film is obtained, the dry thickness of which is approximately 200 micrometers.

Disks with a working surface area of 2 cm² are cut out from this film using a hollow punch.

### Example 2

Carbon paste electrodes are prepared in the same way as described in example 1 using the activated carbon derived from pine wood of 3S quality available from Ceca. This activated carbon is activated in a thin layer at a temperature of 1 000° C. in the presence of steam.

### Example 3

Carbon paste electrodes are prepared in the same way as described in example 1 using the activated carbon derived from pine wood of 4S grade available from Ceca. This activated carbon is obtained by activation at a temperature of 1 000° C. in the presence of steam.

### Example 4

Carbon paste electrodes are prepared in the same way as described in example 1 using the activated carbon derived from pine wood of 5S grade available from Ceca. This activated carbon is obtained by activation at a temperature of 1 000° C. in the presence of steam.

### Example 5 (Comparative Example)

Carbon paste electrodes are prepared in the same way as described in example 1 using Osaka M15 activated carbon (available from Osaka Gas Co. Ltd) obtained from mesophase pitch.

### Example 6 (Comparative Example)

Carbon paste electrodes are prepared in the same way as described in example 1 using activated carbon of Osaka M20 grade (available from Osaka Gas Co. Ltd) obtained from mesophase pitch.

### Example 7 (Comparative Example)

Carbon paste electrodes are prepared in the same way as described in example 1 using activated carbon of Osaka M30 grade (available from Osaka Gas Co. Ltd) obtained from mesophase pitch.

### Example 8 (Comparative Example)

Carbon paste electrodes are prepared in the same way as described in example 1 using activated carbon of Puref-Low grade, available from (Norit Nederland) obtained from inorganic carbon.

### Example 9 (Comparative Example)

Carbon paste electrodes are prepared in the same way as described in example 1 using activated carbon of Norit SX+ grade, available from (Norit Nederland) obtained from peat.

### Example 10 (Comparative Example)

Carbon paste electrodes are prepared in the same way as described in example 1 using activated carbon of Norit SX Ultra grade, available from (Norit Nederland) obtained from peat.

The active surface of the samples is determined by nitrogen adsorption/desorption at 77K. The mean size of the pores and the porosities characteristic of each of the samples are evaluated in the following way. First, the surface of the pore volume having a diameter of less than 20 nm is determined by the method described in ASTM D4365. The concentration of mesopores is evaluated by the method according to ASTM 4641. Finally, the content of macropores is determined by means of the method according to ASTM D4284—intrusion of mercury. The mean diameter of the pores is subsequently calculated from the total pore volume and the BET specific surface according to ASTM D4365 according to the formula D=4V/S.

The results are recorded in table 1 and 2. It is found from these results that the electrodes based on carbons obtained from pine wood have a pore structure differs fundamentally from that observed with regard to electrodes manufactured with other commercially available carbons. Despite a total pore volume exhibiting a broad distribution, the electrodes according to the invention are clearly distinguished by their content of micropores and mesopores. This is because, while the proportion of micropores and mesopores is in balance for the comparative examples, the electrodes according to the invention exhibit less than 32% by volume of micropores and more than 48% by volume of mesopores. In conclusion, the samples obtained from carbons based on pine wood are clearly already distinguished from the comparative samples at the level of their pore structure.

TABLE 1
Specific surface and mean pore diameter

| | BET specific surface | |
|---|---|---|
| Example | (m²/g) | BET Dmean (Å) |
| 1 | 957 | 28.8 |
| 2 | 971 | 31.3 |
| 3 | 1196 | 29.7 |
| 4 | 1382 | 31.3 |
| 5 | 1508 | 18.6 |
| 6 | 2148 | 21.1 |
| 7 | 3284 | 23 |
| 8 | 885 | 29 |
| 9 | 1065 | 28.3 |
| 10 | 1165 | 29.9 |

The electrodes prepared according to examples 1 to 10 are subsequently used to assemble a measurement cell in order to evaluate their performance in a CDLC in terms of power density and energy density. For this, the electrode is first impregnated with a liquid organic electrolyte, a 0.6M solution of tetraethylammonium tetrafluoroborate in γ-butyrolactone, for 1 h 30 at atmospheric pressure. Subsequently, the impregnated electrodes are used to assemble a capacitor as follows. Each of a pair of electrodes is positioned on a plate of treated aluminum and are then assembled face to face separated by a Puma 50/0.30 separating paper (available from Bolloré). The two electrodes are connected to a potentiostat, one being connected first to a calibrated spring.

TABLE 2
Absolute and relative porosity

| | V micro | V meso | V total | | |
|---|---|---|---|---|---|
| Example | (cm³/g) | (cm³/g) | (cm³/g) | % micro | % meso |
| 1 | 0.236 | 0.481 | 0.84 | 28 | 57 |
| 2 | 0.268 | 0.576 | 1.03 | 26 | 56 |
| 3 | 0.306 | 0.645 | 1.11 | 27 | 58 |
| 4 | 0.455 | 0.704 | 1.46 | 31 | 48 |
| 5 | 0.647 | 0.107 | 0.84 | 77 | 13 |
| 6 | 0.719 | 0.43 | 1.30 | 55 | 33 |
| 7 | 1.608 | 1.332 | 3.28 | 49 | 41 |
| 8 | 0.294 | 0.38 | 0.89 | 33 | 43 |
| 9 | 0.384 | 0.42 | 1.06 | 36 | 40 |
| 10 | 0.431 | 0.5 | 1.23 | 35 | 40 |

When a potential difference is applied between the two electrodes of a CDLC, an electrochemical double layer is spontaneously formed at each of the electrode/electrolyte interfaces by accumulation of ionic entities on the side of the electrolyte and of electrical charges on the side of the electrode; the amount of charge thus accumulated is proportional to the voltage applied and to the surface capacity of the electrodes. Each double layer is characterized by its capacity. The overall system is thus defined by 2 capacities in series and the total capacity is expressed by:
1/C=1/C₁+1/C₂

The energy stored is directly proportional to the total capacity of the overall system. The total resistance or alternatively the resistance in series of a capacitor is the second major parameter which characterizes the system. The power of the CDLC is evaluated directly from its value.

The power density and energy density of the electrodes assembled as capacitors is evaluated by chronopotentiometry. The current density used is 1.5 mA/cm² and the limits of the galvanostatic cycling are 0 and 2.5 V. The series resistance and the capacity of the capacitor are deduced from the curve obtained. The series resistance is calculated from the measurement of the ohmic drop at the beginning of the discharge.

The capacity of the capacitor is determined from the slope of the discharge curve:
C=I_{discharge}(Δt/ΔU)

The energy stored is directly proportional to this capacity, in agreement with
E=1/2CV²

The resistance in series is measured from the ohmic drop at the beginning of discharge and after a relaxation phase:
Rₛ=ΔU/I_{discharge}

The power is subsequently determined from the resistance according to the following formula
P=V2/4R

The 2-cm² electrodes are assembled in measurement cells in order to evaluate the energy density and power density. The measurement results are presented in table 3 below.

TABLE 3
Energy density and power density

| Example | E (Wh/kg) | P (kW/kg) |
|---|---|---|
| 1 | 4.051 | 4.200 |
| 2 | 4.340 | 5.157 |
| 3 | 5.008 | 5.669 |
| 4 | 7.750 | 7.247 |
| 5 | 4.886 | 0.657 |
| 6 | 9.177 | 1.276 |
| 7 | 12.478 | 1.878 |
| 8 | 1.680 | 3.818 |
| 9 | 2.480 | 4.895 |
| 10 | 3.673 | 3.980 |

It is seen, from the results, that the electrodes according to the invention exhibit a balanced power density and energy density and that the electrodes of this type are therefore suitable for CDLCs for intermediate applications requiring both a good energy density and a rapid delivery of the energy.

While the carbons which make it possible to deliver an improved power density and energy density are of use in producing the carbon paste used in CDLCs, these carbons can also be of use in other types of electrical devices in which the activated carbon is used as electrode material (such as batteries, “fuel cells”, and the like). This listing of claims will replace all prior versions, and listings, of claims in the application:

1. A process for the preparation of a porous carbonaceous material comprising the following stages:
a) carbonization of wood, preferably of softwood, and advantageously of pine wood, at a temperature of between 500 and 800° C.;
b) thermal activation of the wood carbon obtained in a thin layer at a temperature of between 800 and 1 100° C. in the presence of steam and/or of carbon dioxide; the activated carbon obtained after stage b) exhibiting a volume of mesopores of less than 75% of the total pore volume and a volume of micropores of less than 75% of the total pore volume.

2. The process as claimed in claim 1, in which the activated carbon 15 obtained in stage b) exhibits a content of mesopores of between 40 and 60% of the total pore volume.

3. The process as claimed in claim 1, in which the activated carbon obtained in stage b) exhibits a content of micropores of between 20% and 20 40% of the total pore volume.

4. The process as claimed in claim 1, in which the activated carbon obtained in stage b) exhibits a pore volume of greater than 0.8 cm³/g, preferably of greater than 1 cm³/g.

5. The process as claimed in claim 1, in which the activated carbon obtained in stage b) exhibits a volume of micropores of between 0.2 and 0.6 cm³/g.

6. The process as claimed in claim 1, in which the activated carbon obtained in stage b) exhibits volume of mesopores is of between 0.4 and 0.8 cm³/g.

7. The process as claimed in claim 1, in which the activated carbon obtained after stage b) exhibits a specific surface of greater than 800 m²/g.

8. An electrode based on activated carbon comprising activated carbon capable of being obtained by the process as in claim 1.

9. An electrode based on activated carbon comprising activated carbon based on wood exhibiting a volume of mesopores of less than 75% of the total pore volume and a volume of micropores of less than 75% of the total pore volume.

10. The electrode as claimed in claim 8, characterized in that the electrode comprises activated carbon binder in a ratio by weight of 10/90 to 90/10, 10 preferably of 30/70 to 70/30.

11. The electrode as claimed in claim 8, characterized in that the binder is a polymer, preferably a thermoplastic and advantageously a polyether and/or polyalcohol.

12. A process for the manufacture of an electrode for an electrochemical double-layer energy storage cell comprising the stage of preparation of an activated carbon as claimed in claim 1; application of this activated carbon to a support.

13. The manufacturing process as claimed in claim 12, in which a slip is formed beforehand from the activated carbon derived from pine wood with a binder in a suitable solvent and that the solvent is evaporated after the application to a support.

14. The process as claimed in claim 12, in which the binder is a polymer, preferably a thermoplastic polymer and advantageously a polyether and/or a polyalcohol.

15. The process as claimed in claim 12, in which the activated carbon is mixed with the binder in a ratio by weight of 90/10 to 10/90, preferably of 30/70 to 70/30.

16. The process as claimed in claim 12, in which the application 35 is carried out by coating.

17. An electrochemical double-layer energy storage cell comprising at least one electrode as claimed in claim 8.

18. The cell as claimed in claim 16, exhibiting an energy density of greater than 3 Wh/kg, preferably of greater than 4 Wh/kg, and an energy power of greater than 4 kW/kg, preferably of greater than 5 kW/kg.
